(19) United States
(12) Patent Application Publication
(10) Pub. No.: US 2009/0180302 A1
(43) Pub. Date: Jul. 16, 2009

(54) SWITCHING POWER SUPPLY APPARATUS AND SEMICONDUCTOR DEVICE USED IN THE SWITCHING POWER SUPPLY APPARATUS

(75) Inventors: Keita Kawabe, Osaka (JP); Tetsuji Yamashita, Kyoto (JP)

Correspondence Address: STEPTOE & JOHNSON LLP, 1330 CONNECTICUT AVE., NW, WASHINGTON, DC, 20036, US

(73) Assignee: Panasonic Corporation, Kadoma-shi (JP)

(21) Appl. No.: 12/343,648

(22) Filed: Dec. 24, 2008

(30) Foreign Application Priority Data
Jan. 10, 2008 (JP) 2008-002679

(51) Int. Cl. H02M 3/335

(52) U.S. Cl. 363/21.01

(57) ABSTRACT

A switching power supply apparatus having a highly accurate overvoltage protection function which is free of erroneous operation is provided. A regulating circuit connected to an auxiliary winding generates an AC voltage proportional to a voltage component in which the ringing component has been removed from the AC voltage induced in the auxiliary winding by the switching operation of a switching element. If the peak value of the AC voltage generated by the regulating circuit is equal to or greater than a prescribed value, an overvoltage detection circuit controls the switching operation of the switching element so as to reduce the output DC voltage.

### BACKGROUND OF THE INVENTION

1. Field of the Invention

The present invention relates to a switching power supply apparatus which has an overvoltage protection function, and to a semiconductor device which is used in such a switching power supply apparatus.

2. Description of the Related Art

A switching power supply apparatus is used in order to supply a stable DC voltage to a load. However, due to various reasons, the output DC voltage supplied from a switching power supply apparatus to a load may assume an overvoltage state which is higher than the prescribed voltage. This overvoltage state of the output DC voltage causes damage to the constituent elements of the switching power supply apparatus and to the load. In order to prevent damage of this kind, a switching power supply apparatus has been proposed which has an overvoltage protection function that reduces the output DC voltage in cases where the output DC voltage has assumed an overvoltage state.

FIG. 13 is a circuit diagram showing a first example of the composition of a conventional switching power supply apparatus having an overvoltage protection function. The switching power supply apparatus shown in FIG. 13 is described below.

A switching transformer 31 comprises a primary winding 31a, a secondary winding 31b and an auxiliary winding 31c. An input DC voltage Vin is applied to the primary winding 31a. A switching element 32 is connected in series to the primary winding 31a. The switching operation of the switching element 32 (the operation of repeating turning on and off) is controlled by a control circuit 33. Due to the switching operation of the switching element 32, electrical power is transmitted from the primary winding 31a of the switching transformer 31 to the secondary winding 31b.

The AC voltage induced in the secondary winding 31b of the switching transformer 31 by the switching operation of the switching element 32 is rectified and smoothed by an output voltage generating circuit 34 which comprises a diode 34a and a capacitor 34b, to form an output DC voltage Vout. This output DC voltage Vout is supplied to a load 36.

An output voltage detection circuit 37 detects the voltage level of the output DC voltage Vout, and supplies a feedback signal having a signal level corresponding to the voltage level thus detected, to a feedback terminal FB of the control circuit 33.

The control circuit 33 controls the switching operation of the switching element 32 on the basis of the feedback signal. The energy supplied to the load is regulated by the switching operation on the basis of this feedback signal, and the output DC voltage Vout is thereby stabilized to a prescribed voltage.

The AC voltage induced in the auxiliary winding 31c of the switching transformer 31 by the switching operation of the switching element 32 is rectified and smoothed by a rectifying and smoothing circuit 35 which is constituted by a diode 35a and a capacitor 35b. The voltage which has been rectified and smoothed by the rectifying and smoothing circuit 35 is supplied to the VCC terminal of the control circuit 33. The power which is supplied to the VCC terminal from the auxiliary winding 31c via the rectifying and smoothing circuit 35 forms the operating power of the control circuit 33.

The secondary winding 31b and the auxiliary winding 31c of the switching transformer 31 have the same polarity. Consequently, the voltage of the VCC terminal is proportional to the output voltage Vout. The control circuit 33 has a function of detecting the overvoltage state of the output DC voltage Vout by comparing the voltage at the VCC terminal with a predetermined value, and a function of controlling the switching operation of the switching element 32 in such a manner that the output DC voltage Vout decreases, when an overvoltage state is detected.

As described above, this switching power supply apparatus has a composition in which overvoltage protection is carried out by detecting the overvoltage state of the output DC voltage Vout on the basis of the voltage applied to the VCC terminal.

FIG. 14 is a circuit diagram showing a second example of the composition of a conventional switching power supply apparatus having an overvoltage protection function (see, for example, Japanese Patent Application Laid-open No. 2005-176556). The switching power supply apparatus shown in FIG. 14 is described below. However, members which correspond to members that constitute the switching power supply apparatus shown in FIG. 13 described above are labeled with the same reference numerals and further description thereof is omitted here.

This switching power supply apparatus comprises, in addition to the members provided in the switching power supply apparatus shown in FIG. 13 and described above, resistors 38 and 39, a Zener diode 40 and a capacitor 41. Furthermore, a CS terminal is also provided in the control circuit 33. The junction point between the anode of the Zener diode 40 and the capacitor 41 is connected to this CS terminal. The voltage applied to the VCC terminal of the control circuit 33 is applied to the cathode of the Zener diode 40, via the resistor 39. The Zener voltage of the Zener diode 40 is set in such a manner that when the output DC voltage Vout has assumed an overvoltage state, the capacitor 41 is charged via the Zener diode 40. Consequently, if the output DC voltage Vout assumes an overvoltage state, then the voltage at the CS terminal increases.

The control circuit 33 has a function of detecting the overvoltage state of the output DC voltage Vout by comparing the voltage at the CS terminal with a predetermined value, and a function of controlling the switching operation of the switching element 32 in such a manner that the output DC voltage Vout decreases when an overvoltage state is detected.

As described above, this switching power supply apparatus also has a composition in which overvoltage protection is carried out by detecting the overvoltage state of the output DC voltage Vout on the basis of the voltage applied to the VCC terminal.

However, a switching power supply apparatus having a composition which protects against overvoltage by detecting the overvoltage state of the output DC voltage Vout on the basis of the voltage applied to the VCC terminal involves the following problems.

FIG. 15 is a diagram showing the waveform of the AC voltage induced in the auxiliary winding 31c. As shown in FIG. 15, a ringing component occurs when the voltage of the auxiliary winding 31c changes from a low potential to a high potential. Since the current flowing to the VCC terminal from the auxiliary winding 31c is extremely small, then the voltage at the VCC terminal, to which a voltage obtained by rectifying and smoothing the voltage of the auxiliary winding 31c is applied, is liable to be affected by the ringing component which occurs in the rising portion of the voltage in the auxiliary winding 31. Consequently, if the ringing component becomes greater, then the voltage at the VCC terminal tends to become higher.

FIG. 16 is a diagram showing the relationship between the voltage of the VCC terminal and the output power during the normal operation of a switching power supply apparatus which carries out overvoltage protection by detecting the overvoltage state of the output DC voltage Vout on the basis of the voltage applied to the VCC terminal. The magnitude of the ringing component occurring in the rising portion of the voltage in the auxiliary winding 31c is largely dependent on the magnitude of the output power, and if the output power becomes larger, then a greater ringing component occurs in the voltage of the auxiliary winding 31c. Consequently, as shown in FIG. 16, if the output power becomes larger, then the voltage at the VCC terminal becomes higher. In particular, in cases where a large ringing component occurs in the voltage of the auxiliary winding 31c, for instance, cases where there is high leakage inductance in the auxiliary winding 31c, then the voltage at the VCC terminal varies greatly in accordance with changes in the output power. Consequently, in a switching power supply apparatus which protects against overvoltage by detecting the overvoltage state of the output DC voltage Vout on the basis of the voltage applied to the VCC terminal, disparities arise in the voltage level of the output DC voltage Vout at which the overvoltage protection operates, due to differences in the properties between the circuit components.

As described above, a switching power supply apparatus which carries out overvoltage protection by detecting the overvoltage state of the output DC voltage Vout on the basis of the voltage applied to the VCC terminal has problems in that it does not enable overvoltage protection to be carried out with good accuracy.

Furthermore, even during the normal operation when the output DC voltage Vout is stabilized to a prescribed voltage, if the output power has increased due to the effects of the ringing component which occurs in the voltage of the auxiliary winding 31c as described above, then the voltage at the VCC terminal may increase to the voltage at which the overvoltage protection operates, and therefore an overvoltage state of the output DC voltage Vout may be detected erroneously.

In this way, a switching power supply apparatus which carries out overvoltage protection by detecting the overvoltage state of the output DC voltage Vout on the basis of the voltage applied to the VCC terminal has a problem in that the overvoltage protection may operate erroneously, regardless of the fact that the output DC voltage Vout is not in an overvoltage state.

Furthermore, in a switching power supply apparatus which uses a ringing choke converter system as the method for controlling the switching operation of the switching element, when the overvoltage state of the output DC voltage Vout has occurred, if the terminal for detecting this overvoltage state is open and operation of the overvoltage protection is no longer possible, then the switching operation of the switching element continues. Therefore, the overvoltage state of the output DC voltage Vout is maintained for a long period of time, and depending on the circumstances, there is a possibility that the output DC voltage Vout may increase to an even higher voltage and give rise to breaking down of the load or component parts of the switching power supply apparatus.

### SUMMARY OF THE INVENTION

The present invention was devised in view of the problems described above, an object thereof being to provide a switching power supply apparatus which is capable of achieving highly accurate overvoltage protection that is free of erroneous operation, and a semiconductor device which is used in this switching power supply apparatus, without an increase in costs due to the addition of special components.

In order to achieve the aforementioned object, the switching power supply apparatus according to the present invention comprises: a switching transformer having a primary winding, a secondary winding and an auxiliary winding; a switching element connected to the primary winding; an output voltage generating circuit, connected to the secondary winding, for generating an output DC voltage by rectifying and smoothing an AC voltage induced in the secondary winding by a switching operation of the switching element; a regulating circuit, connected to the auxiliary winding, for generating an AC voltage proportional to a voltage component in which a ringing component of an AC voltage induced in the auxiliary winding by the switching operation of the switching element has been removed; and a control circuit for controlling the switching operation of the switching element, wherein the control circuit comprises an overvoltage detection circuit for controlling the switching operation of the switching element so as to reduce the output DC voltage when the peak value of the AC voltage generated by the regulating circuit becomes equal to or greater than a prescribed value.

Furthermore, in the switching power supply apparatus according to the present invention, the regulating circuit of the switching power supply apparatus described above comprises a voltage dividing circuit constituted by a plurality of resistors.

Furthermore, in the switching power supply apparatus described above, if the peak value of a pulse of the AC voltage generated by the regulating circuit becomes equal to or greater than a prescribed value, the overvoltage detection circuit counts the number of times that the peak value is successively equal to or greater than the prescribed value, and if the number of times thus counted reaches a predetermined value, the overvoltage detection circuit controls the switching operation of the switching element so as to reduce the output DC voltage.

Furthermore, in the switching power supply apparatus described above, if the peak value of a pulse of the AC voltage generated by the regulating circuit becomes equal to or greater than a prescribed value, the overvoltage detection circuit starts monitoring a high peak time period during which the peak value is successively equal to or greater than the prescribed value, and if the high peak time period reaches a predetermined set monitoring time period, the overvoltage detection circuit controls the switching operation of the switching element so as to reduce the output DC voltage.

Furthermore, in the switching power supply apparatus described above, the control circuit comprises an oscillating circuit for generating a pulse signal having a fixed period that determines the on timing of the switching element.

Moreover, in the switching power supply apparatus described above, the control circuit comprises a turn-on detection circuit for generating a signal to turn on the switching element when it is detected, on the basis of the AC voltage generated by the regulating circuit, that the voltage level of ringing occurring in the auxiliary winding while current is not flowing in the secondary winding becomes equal to or lower than a prescribed voltage.

Furthermore, the semiconductor device relating to the present invention is a semiconductor device used in the switching power supply apparatus described above, wherein the switching element and the control circuit are formed on the same semiconductor substrate, or are incorporated into the same package.

According to a desirable mode of the present invention, the AC voltage generated by the regulating circuit only depends on changes in the output DC voltage and does not depend on changes in the output power. Since overvoltage protection is operated by detecting that the output DC voltage is in an overvoltage state on the basis of the AC voltage generated by the regulating circuit, then it is possible to carry out highly precise and accurate overvoltage protection, and it is also possible to prevent erroneous operation of overvoltage protection during normal operation.

Furthermore, according to a desirable mode of the present invention, it is possible to freely set the voltage level of the output DC voltage at which the overvoltage protection operates, simply by adjusting the constants of the parts which constitute the regulating circuit, without changing the design of the switching transformer. Consequently, it is possible to improve the freedom of the design of the power supply.

Moreover, according to a desirable mode of the present invention, by providing, instead of the oscillating circuit, a turn-on detection circuit which controls the turning on of the switching element on the basis of the AC voltage generated by the regulating circuit, then even if overvoltage protection is not carried out due to the occurrence of an abnormal state caused by an open connection of a terminal which supplies the AC voltage generated by the regulating circuit to the overvoltage detection circuit which detects the overvoltage state of the output DC voltage and to the turn-on detection circuit, simultaneously with this, the switching operation of the switching element is halted and therefore it is possible to cause the output DC voltage to fall. Therefore, it is possible to improve the reliability of the switching power supply apparatus.

The switching power supply apparatus according to the present invention and the semiconductor device used in this switching power supply apparatus are useful in switching power supply apparatuses and various electronic equipment which incorporates switching power supply apparatuses, and are particularly useful in electronic equipment which requires overvoltage protection to prevent overvoltage from being applied to various loads (apparatuses, and the like) which are connected to the switching power supply apparatus.

### BRIEF DESCRIPTION OF THE DRAWINGS

FIG. 1 is a circuit diagram showing one example of the composition of a switching power supply apparatus relating to a first embodiment of the present invention;

FIG. 2 is a circuit diagram showing one example of the composition of a semiconductor device which is used in the switching power supply apparatus relating to the first embodiment of the present invention;

FIG. 3 is a diagram showing operating waveforms in the switching power supply apparatus relating to the first embodiment of the present invention;

FIG. 4 is a diagram showing one example of the operating waveforms of a self-reset type of overvoltage protection in the switching power supply apparatus relating to the first embodiment of the present invention;

FIG. 5 is a diagram showing a further example of the operating waveforms of the self-reset type of overvoltage protection in the switching power supply apparatus relating to the first embodiment of the present invention;

FIG. 6 is a diagram showing the relationship between the peak value of a voltage at the OV terminal and the output power during the normal operation of the switching power supply apparatus relating to the first embodiment of the present invention;

FIG. 7 is a circuit diagram showing one example of the composition of an overvoltage detection circuit provided in a semiconductor device which is used in a switching power supply apparatus relating to a second embodiment of the present invention;

FIG. 8 is a diagram showing operating waveforms in the switching power supply apparatus relating to the second embodiment of the present invention;

FIG. 9 is a circuit diagram showing one example of the composition of an overvoltage detection circuit provided in a semiconductor device which is used in a switching power supply apparatus relating to a third embodiment of the present invention;

FIG. 10 is a diagram showing operating waveforms in the switching power supply apparatus relating to the third embodiment of the present invention;

FIG. 11 is a circuit diagram showing one example of the composition of a semiconductor device which is used in a switching power supply apparatus relating to a fourth embodiment of the present invention;

FIG. 12 is a circuit diagram showing one example of the composition of a switching power supply apparatus relating to a fifth embodiment of the present invention;

FIG. 13 is a circuit diagram showing a first example of the composition of a conventional switching power supply;

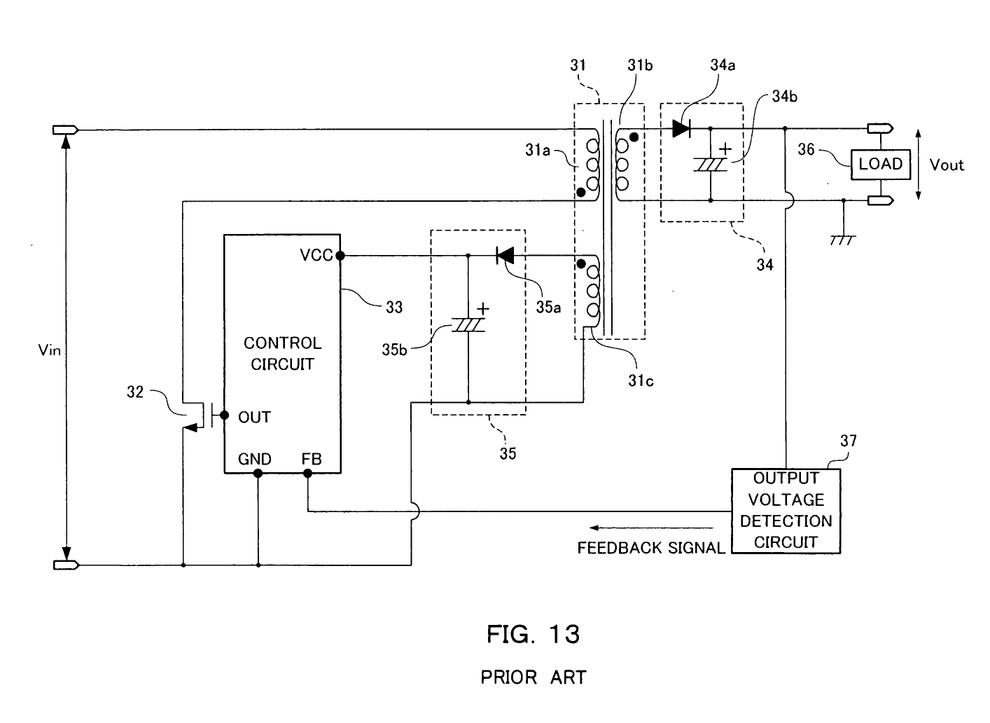

FIG. 14 is a circuit diagram showing a second example of the composition of a conventional switching power supply;

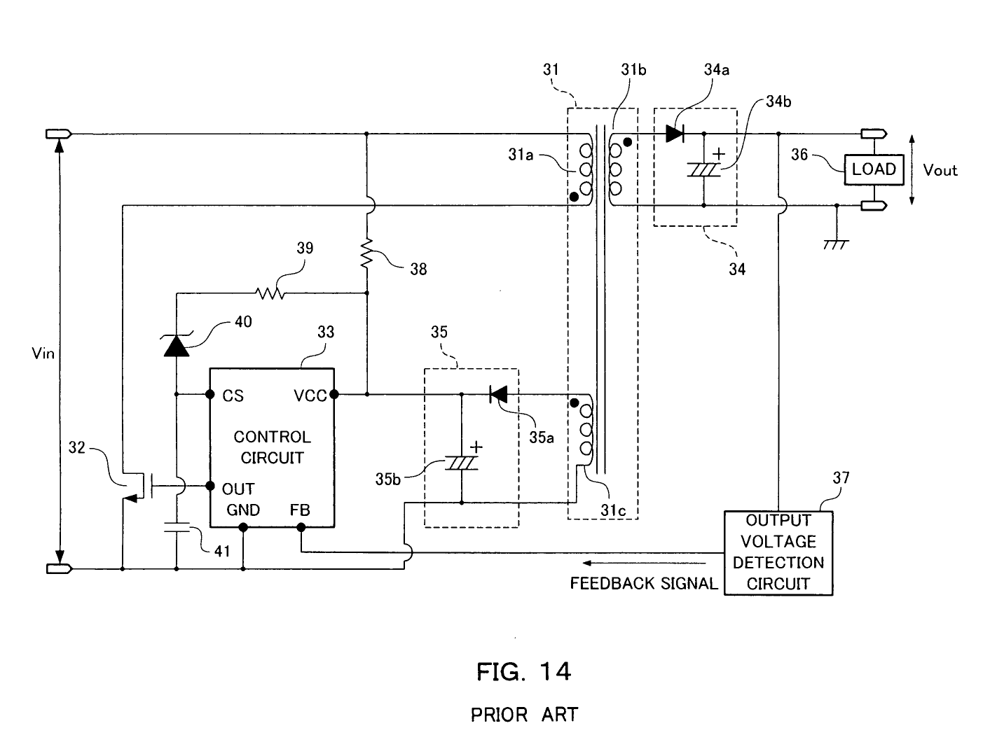

FIG. 15 is a diagram showing the voltage waveforms of an auxiliary winding in a switching power supply apparatus relating to an embodiment of the present invention and a conventional switching power supply apparatus; and

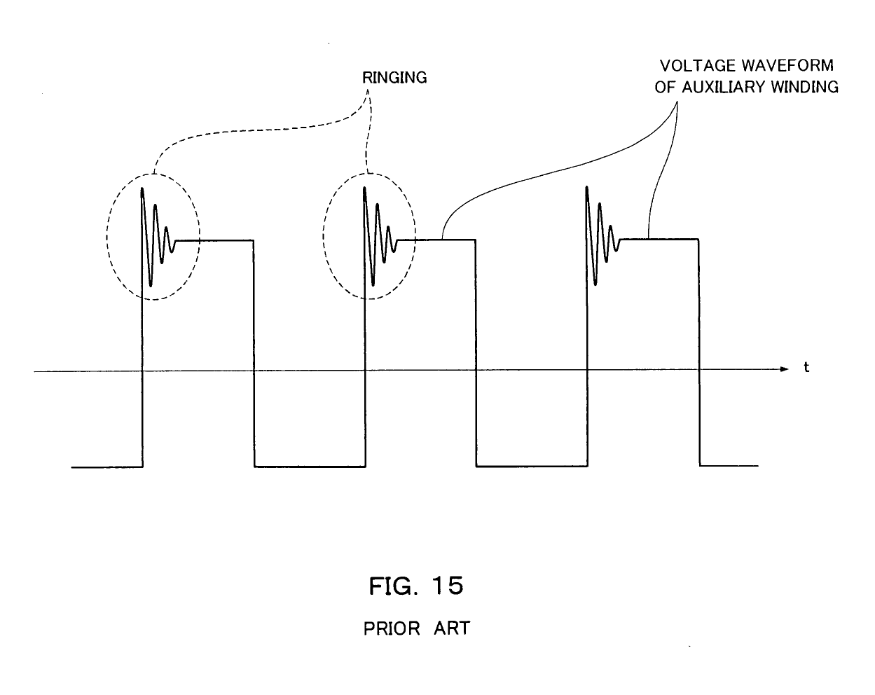

FIG. 16 is a diagram showing the relationship between a voltage at the VCC terminal and the output power during the normal operation of a conventional switching power supply apparatus.

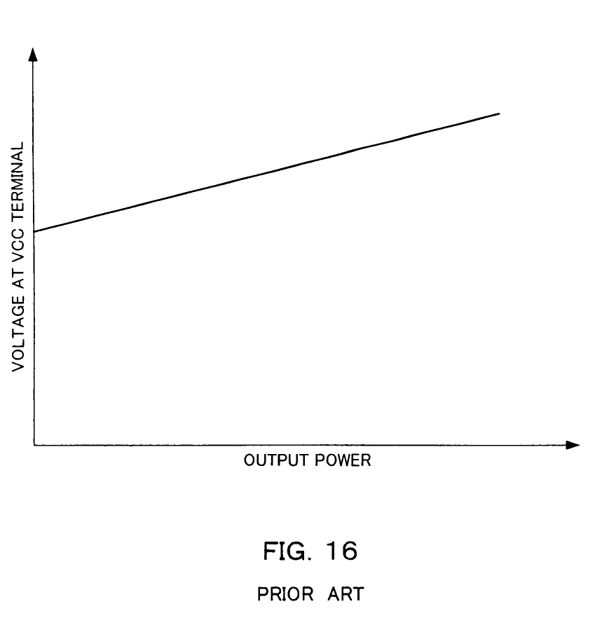

### DESCRIPTION OF THE PREFERRED EMBODIMENTS

### First Embodiment

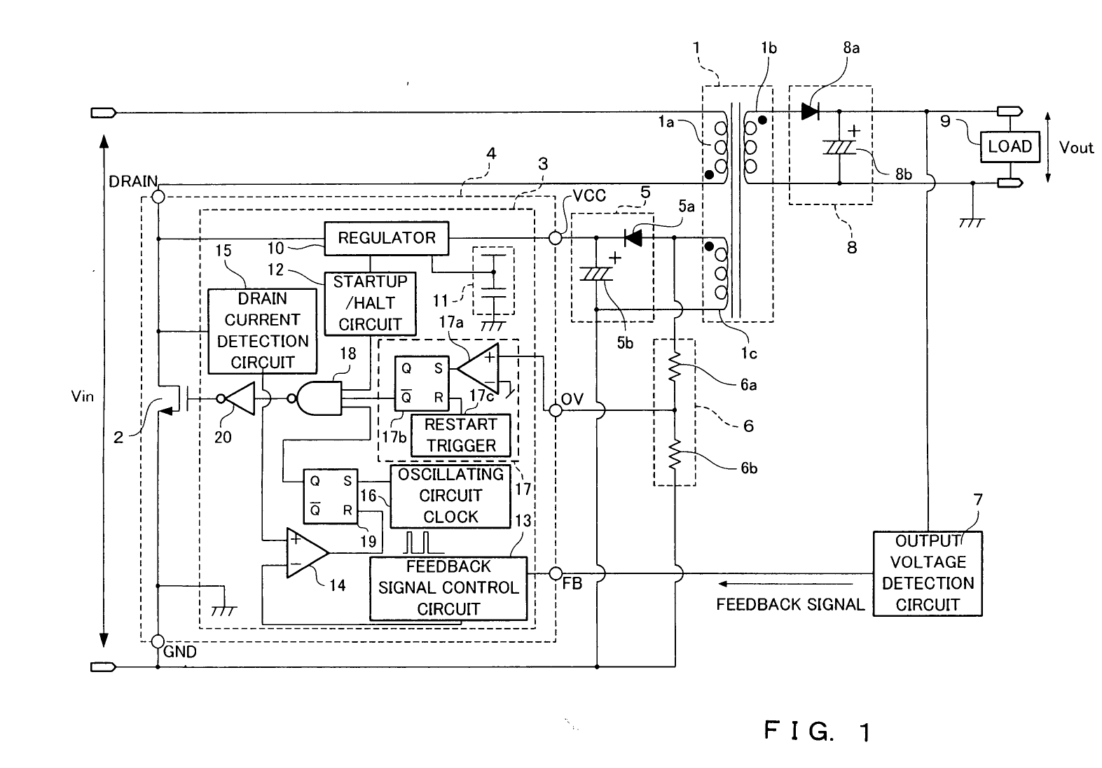

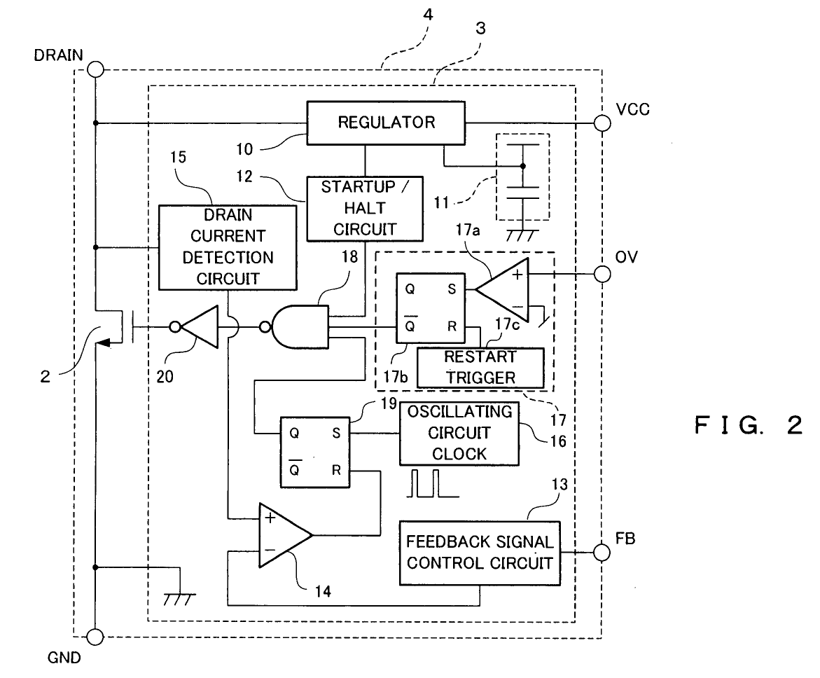

Below, one example of the composition of a switching power supply apparatus relating to a first embodiment of the present invention and a semiconductor device used in this switching power supply apparatus will be described with reference to the drawings. FIG. 1 is a circuit diagram which shows one example of the composition of the switching power supply apparatus relating to the first embodiment of the present invention, and FIG. 2 is a circuit diagram which shows one example of the composition of the semiconductor device which is used in this switching power supply apparatus. This switching power supply apparatus uses current-mode PWM control as a method for controlling the switching operation of a switching element.

As shown in FIG. 1, a switching transformer 1 comprises a primary winding 1a, a secondary winding 1b and an auxiliary winding 1c. The primary winding 1a and the secondary winding 1b have opposite polarities, and the switching power supply apparatus is a flyback type of device.

A switching element 2 is connected in series to the primary winding 1a. The gate of this switching element 2 is connected to a gate driver 20 of a control circuit 3, and the switching element 2 performs a switching operation in accordance with a gate signal (control signal) generated by the gate driver 20. In this way, the switching operation of the switching element 2 is controlled by means of the control signal generated by the control circuit 3.

A semiconductor device 4 is constituted by the switching element 2 and the control circuit 3. The semiconductor device 4 has five external input terminals, namely, a DRAIN terminal, a GND terminal, a VCC terminal, an OV terminal and an FB terminal.

The DRAIN terminal is connected inside the semiconductor device 4 to the drain of the switching element 2 and a regulator 10 of the control circuit 3, and is connected outside the semiconductor device 4 to the primary winding 1a of the switching transformer 1. The GND terminal is connected inside the semiconductor device 4 to the source of the switching element 2 and the GND line of the control circuit 3, and is connected outside the semiconductor device 4 to the low-potential side terminal of the input terminals to which an input DC voltage Vin is applied. In other words, the GND terminal is set to the level of the source of the switching element 2, and the level of the GND line of the control circuit 3 is set to ground (earth) level.

The VCC terminal is connected inside the semiconductor device 4 to the regulator 10 of the control circuit 3 and is connected outside the semiconductor device 4 to a rectifying and smoothing circuit 5. The OV terminal is connected inside the semiconductor device 4 to an overvoltage detection circuit 17 of the control circuit 3 and is connected outside the semiconductor device 4 to a regulating circuit 6. The FB terminal is connected inside the semiconductor device 4 to a feedback signal control circuit 13 of the control circuit 3 and is connected outside the semiconductor device 4 to an output voltage detection circuit 7.

When the input DC voltage Vin is applied to the primary winding 1a and the switching operation of the switching element 2 is started, then electric power is transmitted from the primary winding 1a of the switching transformer 1 to the secondary winding 1b and the auxiliary winding 1c.

An output voltage generating circuit 8 which is constituted by a diode 8a and a capacitor 8b is connected to the secondary winding 1b. This output voltage generating circuit 8 generates an output DC voltage Vout by rectifying and smoothing an AC voltage which is induced in the secondary winding 1b by the switching operation of the switching element 2. This output DC voltage Vout is applied to a load 9.

The output voltage detection circuit 7 detects the voltage level of the output DC voltage Vout. The control circuit 3 which is connected to the output voltage detection circuit 7 via the FB terminal controls the switching operation of the switching element 2 on the basis of the voltage level of the output DC voltage Vout detected by the output voltage detection circuit 7 in such a manner that the output DC voltage Vout is stabilized to a prescribed voltage. More specifically, the output voltage detection circuit 7 generates a feedback signal which indicates the voltage level of the output DC voltage Vout. The feedback signal control circuit 13 of the control circuit 3 controls the timing at which the switching element 2 is turned off, on the basis of the feedback signal supplied via the FB terminal.

The rectifying and smoothing circuit 5 which is constituted by a diode 5a and a capacitor 5b is connected to the auxiliary winding 1c. This rectifying and smoothing circuit 5 generates an output DC voltage by rectifying and smoothing an AC voltage which is induced in the auxiliary winding 1c by the switching operation of the switching element 2. The DC voltage generated by this rectifying and smoothing circuit 5 is applied to the VCC terminal of the semiconductor device 4 as an auxiliary power supply voltage VCC of the control circuit 3.

The regulating circuit 6 is connected to the junction point between the auxiliary winding 1c and the rectifying and smoothing circuit 5. Here, a case is described in which a voltage dividing circuit constituted by two voltage dividing resistors 6a and 6b is used as the regulating circuit 6. If a voltage dividing circuit constituted by voltage dividing resistors is used as the regulating circuit 6 in this way, then these voltage dividing resistors remove a ringing component which occurs in the rising portion of the AC voltage induced in the auxiliary winding 1c due to the switching operation of the switching element 2, and therefore, in the regulating circuit 6, it is possible to generate an AC voltage proportional to a voltage component in which the ringing component of the AC voltage induced in the auxiliary winding 1c has been removed. The AC voltage generated by the regulating circuit 6 is applied to the OV terminal of the semiconductor device 4.

An AC voltage which is proportional to the AC voltage induced in the secondary winding 1b is induced in the auxiliary winding 1c, and therefore the AC voltage generated by the regulating circuit 6 is an AC voltage which is proportional to a voltage component which excludes the ringing component of the AC voltage induced in the secondary winding 1b.

Here, the example was described in which the regulating circuit 6 is constituted by the two voltage dividing resistors 6a and 6b, but of course the number of resistors is not limited to two. Furthermore, the case where the regulating circuit 6 is constituted by voltage dividing resistors was described, but the composition is not limited to this, provided that the regulating circuit 6 is a circuit which is capable of generating an AC voltage that is proportional to a voltage component which excludes the ringing component of the AC voltage induced in the auxiliary winding 1c.

Next, the control circuit 3 incorporated into the semiconductor device 4 will be described. As shown in FIG. 2, the regulator 10 is connected to the DRAIN terminal and the VCC terminal of the semiconductor device 4. If the auxiliary power supply voltage VCC applied to the VCC terminal is equal to or greater than a prescribed value, the regulator 10 stabilizes the voltage of an internal circuit power supply 11 to a uniform voltage, by supplying current to the internal circuit power supply 11 of the semiconductor device 4 from the VCC terminal. On the other hand, if the auxiliary power supply voltage VCC applied to the VCC terminal is lower than the prescribed value, then the regulator 10 supplies current to the internal circuit power supply 11 and the VCC terminal from the DRAIN terminal.

More specifically, upon startup immediately after the application of an input DC voltage Vin, the regulator 10 supplies current to the internal circuit power supply 11 from the DRAIN terminal until the switching element 2 starts a switching operation, whereas it supplies current to the capacitor 5b of the rectifying and smoothing circuit 5 from the DRAIN terminal and via the VCC terminal. Thereby, the voltage of the internal circuit power supply 11 increases, while the auxiliary power supply voltage VCC also increases.

Consequently, if the auxiliary power supply voltage VCC reaches a startup voltage VCCON which is previously set in a startup/halt circuit 12, then the startup/halt circuit 12 switches the level of the signal supplied to the input terminal of a 3-input NAND circuit 18 from level L to level H. Furthermore, in this case, a pulse signal CLOCK having a fixed period is generated by an oscillating circuit 16. As a result, a switching operation of the switching element 2 is started.

When the switching operation starts, current is supplied to the VCC terminal from the auxiliary winding 1c via the rectifying and smoothing circuit 5. After the switching operation of the switching element 2 has started, the regulator 10 stops the supply of current from the DRAIN terminal to the internal circuit power supply 11 and the VCC terminal, but on the other hand, it supplies current to the internal circuit power supply 11 from the VCC terminal. By this means, the voltage of the internal circuit power supply 11 is stabilized to a uniform value.

Furthermore, after the switching operation of the switching element 2 has started, if for some reason the auxiliary power supply voltage VCC falls to a halt voltage VCCOFF previously set in the startup/halt circuit 12, then the startup/halt circuit 12 switches the level of the signal supplied to the input terminal of a NAND circuit 18, from level H to level L. By this means, the switching operation of the switching element 2 is halted. In this case, the regulator 10 supplies current to the internal circuit power supply 11 from the DRAIN terminal, while on the other hand it supplies current to the capacitor 5b of the rectifying and smoothing circuit 5 from the DRAIN terminal and via the VCC terminal.

As stated previously, the startup/halt circuit 12 has a function of starting the switching operation of the switching element 2 by switching the level of the signal supplied to the input terminal of the NAND circuit 18 from level L to level H, if the auxiliary power supply voltage VCC at startup is equal to or greater than the startup voltage VCCON. Furthermore, the startup/halt circuit 12 has a function of halting the switching operation of the switching element 2 by switching the level of the signal supplied to the input terminal of the NAND circuit 18 from level H to level L, if the auxiliary power supply voltage VCC falls to the halt voltage VCCOFF, due to some reason, while the switching element 2 is performing a switching operation.

The feedback signal control circuit 13 is connected to the FB terminal of the semiconductor device 4. This feedback signal control circuit 13 generates a voltage signal for stabilizing the output DC voltage Vout to a uniform voltage, on the basis of the feedback signal generated by the output voltage detection circuit 7. The voltage signal generated by this feedback signal control circuit 13 is supplied to one input terminal of a comparator 14.

More specifically, since the signal level of the feedback signal is also uniform if the output DC voltage Vout is uniform, then the feedback signal control circuit 13 supplies a voltage signal having a uniform voltage level to the input terminal of the comparator 14. On the other hand, if the output DC voltage Vout changes (for example, increases), and the signal level of the feedback signal changes (increases), then the feedback signal control circuit 13 changes (decreases) the voltage level of the voltage signal supplied to the input terminal of the comparator 14, in response to the change of the signal level (increase in the signal level) of the feedback signal.

A drain current detection circuit 15 detects the current level of current (drain current) ID flowing in the switching element 2, and generates a voltage signal having a voltage level proportional to the current level thus detected. The voltage signal generated by this drain current detection circuit 15 is supplied to the other input terminal of the comparator 14.

The comparator 14 compares the voltage signal generated by the drain current detection circuit 15 with the voltage signal generated by the feedback signal control circuit 13. If the voltage level of the voltage signal generated by the drain current detection circuit 15 is equal to or greater than the voltage level of the voltage signal generated by the feedback signal control circuit 13, then the comparator 14 switches the level of the signal supplied to the R (reset) terminal of a flip-flop circuit 19, from level L to level H. The off timing of the switching element 2 is determined by the signal supplied to the R terminal of the flip-flop circuit 19 by the comparator 14.

The oscillating circuit 16 generates a pulse signal CLOCK having a fixed period. This pulse signal CLOCK is supplied to the S (set) terminal of the flip-flip circuit 19. The on timing of the switching element 2 is determined by this pulse signal CLOCK.

The output terminal (Q terminal) of the flip-flop circuit 19 is connected to the input terminal of the NAND circuit 18. After the pulse signal CLOCK supplied to the S terminal has risen and until the signal supplied to the R terminal has risen, the flip-flop circuit 19 holds the level of the signal supplied to the input terminal of the NAND circuit 18 at level H, and after the signal supplied to the R terminal has risen and until the pulse signal CLOCK supplied to the S terminal has risen, the flip-flop circuit 19 holds the level of the signal supplied to the input terminal of the NAND circuit 18 at level L. The switching element 2 performs a switching operation in accordance with the signal supplied to the NAND circuit 18 from this flip-flop circuit 19.

The overvoltage detection circuit 17 is connected to the OV terminal of the semiconductor device 4. When the voltage applied to the OV terminal is equal to or greater than a predetermined fixed value VOV, then the overvoltage detection circuit 17 reduces the output DC voltage Vout by generating a signal which halts the switching operation of the switching element 2. The overvoltage detection circuit 17 detects an overvoltage state of the output DC voltage Vout by comparing the voltage at the OV terminal with the fixed value VOV.

More specifically, the overvoltage detection circuit 17 comprises a comparator 17a, a flip-flop circuit 17b, and a restart trigger 17c. One input terminal of the comparator 17a is connected to the OV terminal of the semiconductor device 4, and the inverse output terminal (/Q terminal) of the flip-flop circuit 17b is connected to the input terminal of the NAND circuit 18.

If the voltage at the OV terminal (the AC voltage generated by the regulating circuit 6) is lower than the reference voltage (fixed value) VOV of the comparator 17a, then the comparator 17a supplies a signal having a low signal level L to the S (set) terminal of the flip-flop circuit 17b. By this means, the level of the signal supplied to the input terminal of the NAND circuit 18 from the flip-flip circuit 17b is kept at level H.

If the voltage at the OV terminal is equal to or greater than the reference voltage VOV of the comparator 17a, then the level of the signal supplied from the comparator 17a to the S terminal of the flip-flop circuit 17b switches from level L to level H, and the level of the signal supplied from the flip-flop circuit 17b to the input terminal of the NAND circuit 18 switches from level H to level L, and the switching operation of the switching element 2 is halted.

Thereupon, the flip-flop circuit 17b continues to supply a signal having an L signal level to the input terminal of the NAND circuit 18, until a restart signal is generated by the restart trigger 17c which is connected to the R (reset) terminal. By this means, the switching operation of the switching element 2 continues to be halted and the output DC voltage Vout falls.

When the output DC voltage Vout falls and the voltage of the internal circuit power supply 11 falls to a predetermined voltage level, the restart trigger 17c generates a restart signal.

When a restart signal is supplied to the R terminal of the flip-flop circuit 17b from the restart trigger 17c, the level of the signal supplied from the flip-flop circuit 17b to the input terminal of the NAND circuit 18 is switched from level L to level H. Thereby, the control circuit 3 assumes a state where the switching operation of the switching element 2 can be restarted.

The output terminal of the three-input NAND circuit 18 is connected to the input terminal of the gate driver 20. When the levels of the signals supplied to the three input terminals are all level H, the NAND circuit 18 supplies a signal having an H signal level to the input terminal of the gate driver 20. On the other hand, when the level of any one of the signals supplied to the three input terminals is level L, the NAND circuit 18 supplies a signal having an L signal level to the input terminal of the gate driver 20.

The output terminal of the gate driver 20 is connected to the gate of the switching element 2. If the pulse signal CLOCK has risen and all of the signals supplied to the three input terminals of the NAND circuit 18 have assumed level H, while the level of the signal supplied from the NAND circuit 18 to the gate driver 20 has switched from level H to level L, then the gate driver 20 changes the switching element 2 from an off state to an on state (in other words, the gate driver 20 turns on the switching element 2). On the other hand, if the current level of the drain current ID detected by the drain current detection circuit 15 has reached a value determined by the voltage level of the voltage signal generated by the feedback signal control circuit 13, and a signal of L signal level is supplied to the input terminal of the NAND circuit 18, whereby the signal supplied from the NAND circuit 18 to the gate driver 20 switches from a signal of level L to a signal of level H, then the gate driver 20 changes the switching element 2 from an on state to an off state (in other words, the gate driver 20 turns off the switching element 2). In this way, the switching power supply apparatus achieves current-mode PWM control which stabilizes the output DC voltage Vout to a uniform voltage by controlling the peak value of the drain current ID.

Next, the operation of the present switching power supply apparatus when the output DC voltage Vout has assumed an overvoltage state will be described. If the output DC voltage Vout which is controlled so as to be stabilized to a uniform voltage increases for some reason during normal operation, then the peak value of the AC voltage induced in the secondary winding 1b also increases. For example, in an abnormal state where the output voltage detection circuit 7 is open, it is not possible to generate the feedback signal necessary in order to control the switching operation of the switching element 2 in such a manner that the output DC voltage Vout is stabilized to a uniform voltage, and hence a phenomenon occurs in which the output DC voltage Vout rises greatly. This phenomenon gives rise to an increase in the peak value of the AC voltage induced in the secondary winding 1b.

As stated previously, a voltage which is proportional to the AC voltage induced in the secondary winding 1b is induced in the auxiliary winding 1c, and the AC voltage generated by the regulating circuit 6 which is connected to the auxiliary winding 1c is proportional to a voltage component in which the ringing component of the AC voltage induced in the secondary winding 1b has been removed. Consequently, when the peak value of the AC voltage generated in the secondary winding 1b increases due to the increase in the output DC voltage Vout, then the peak value of the AC voltage applied to the OV terminal of the semiconductor device 4 also increases.

From the foregoing, if the output DC voltage Vout has assumed an overvoltage state, the AC voltage applied to the OV terminal of the semiconductor device 4 has reached the fixed value VOV, and an overvoltage state of the output DC voltage Vout has been detected by the overvoltage detection circuit 17, then the level of the signal supplied to the input terminal of the NAND circuit 18 from the overvoltage detection circuit 17 switches from level H to level L, and the level of the signal supplied to the input terminal of the gate driver 20 assumes level H. Accordingly, the switching element 2 is controlled in such a manner that it is not turned on.

When the output DC voltage Vout has assumed an overvoltage state, the overvoltage detection circuit 17 continues to generate a signal having an L level, and hence the off state of the switching element 2 is continued. As a result, a state where power is transmitted from the primary winding 1a to the secondary winding 1b of the switching transformer 1 continues, and therefore the output DC voltage Vout declines and the overvoltage state of the output DC voltage Vout ceases. By this means, it is possible to protect the load 9 and the constituent parts of the switching power supply apparatus from overvoltage.

As described above, according to this switching power supply apparatus, it is possible to achieve a latch-pause type of overvoltage protection whereby a state of reduced output DC voltage Vout is maintained.

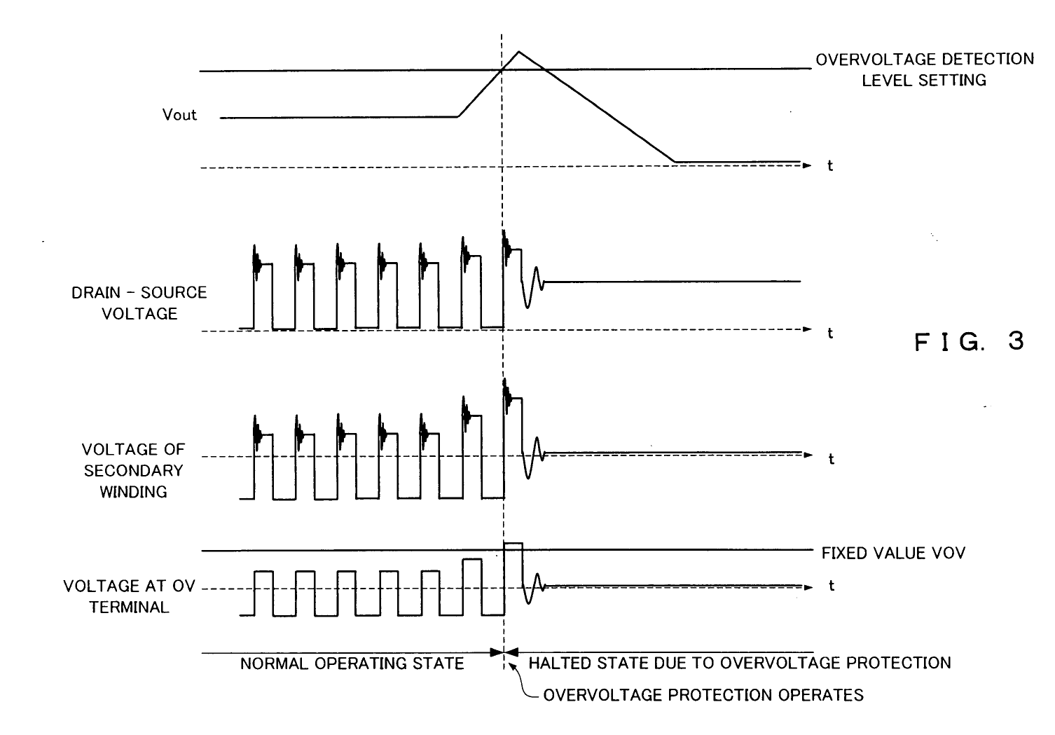

FIG. 3 shows the operating waveforms of the present switching power supply apparatus when the output DC voltage Vout assumes an overvoltage state and the overvoltage protection operates. FIG. 3 shows the output DC voltage Vout, the drain—source voltage of the switching element 2, the AC voltage induced in the secondary winding 1b, and the AC voltage occurring in the OV terminal.

As shown in FIG. 3, the fixed value VOV is set to a voltage which is higher than the peak value of the voltage at the OV terminal during normal operation. When the output DC voltage Vout assumes an overvoltage state and the voltage at the OV terminal reaches the fixed value VOV, then the overvoltage detection circuit 17 switches the level of the signal supplied to the input terminal of the NAND circuit 18 from level H to level L. By this means, the switching operation of the switching element 2 is halted and the output DC voltage Vout falls.

In the first embodiment of the present invention, the example using a latch-pause type of overvoltage protection was described, in which the output timing of the restart signal created by the restart trigger 17c is determined by the voltage level of the internal circuit power supply 11, but the overvoltage protection of the present invention is not limited to this example, and it is also possible, for instance, to employ a self-reset type of overvoltage protection in which the output timing of the restart signal is determined on the basis of the behavior of the voltage at the VCC terminal. Two examples of a self-reset type of overvoltage protection are described below.

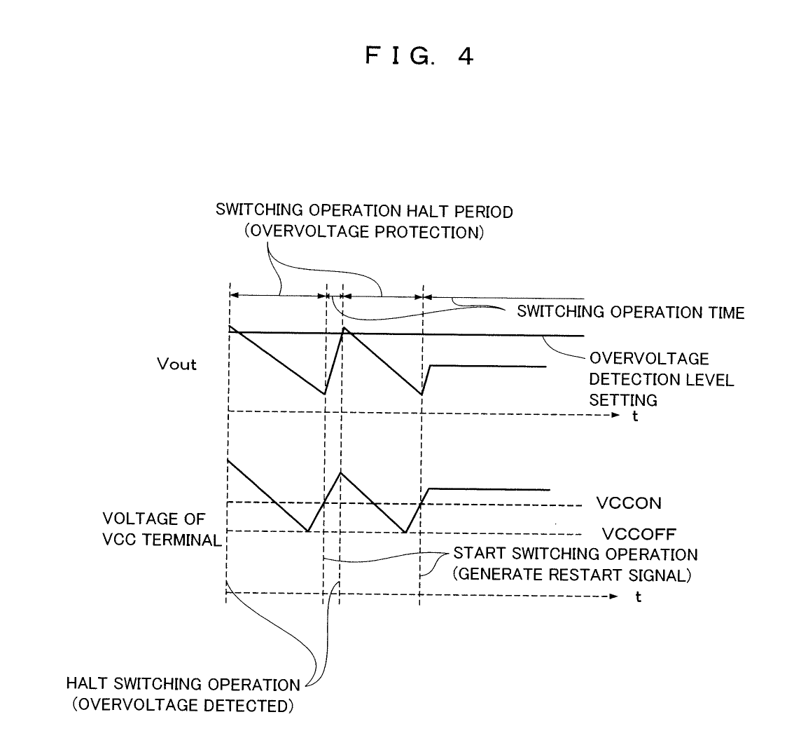

Firstly, a description is given of a self-reset type of overvoltage protection in a switching power supply apparatus which comprises a restart trigger 17c that generates a restart signal when the voltage at the VCC terminal reaches the startup voltage VCCON. FIG. 4 shows the operating waveforms of the present switching power supply apparatus when the output DC voltage Vout assumes an overvoltage state and the overvoltage protection operates. FIG. 4 shows the output DC voltage Vout and the voltage at the VCC terminal.

As stated previously, if the output DC voltage Vout has assumed an overvoltage state and the AC voltage applied to the OV terminal of the semiconductor device 4 has reached the fixed value VOV, then the level of the signal supplied to the input terminal of the NAND circuit 18 from the overvoltage detection circuit 17 switches from level H to level L, the level of the signal supplied to the input terminal of the gate driver 20 assumes level H, and the switching element 2 is controlled in such a manner that it is not turned on.

When the switching operation of the switching element 2 is halted, then as shown in FIG. 4, the output DC voltage Vout falls and furthermore the voltage at the VCC terminal falls. When the voltage at the VCC terminal has fallen to the halt voltage VCCOFF, then as stated previously, the current supply from the DRAIN terminal to the VCC terminal is started, and therefore the voltage at the VCC terminal increases to the startup voltage VCCON. When the voltage at the VCC terminal has reached the startup voltage VCCON, then the restart trigger 17c generates a restart signal. As a result, the level of the signal supplied from the flip-flop circuit 17b to the input terminal of the NAND circuit 18 switches from level L to level H, and the switching operation of the switching element 2 is restarted. In this case, if the overvoltage state has not been resolved, then the AC voltage applied to the OV terminal subsequently reaches the fixed value VOV, and therefore the switching operation of the switching element 2 is halted again and the output DC voltage Vout and the voltage at the VCC terminal fall. Consequently, this operation is repeated and overvoltage protection is continued, until the abnormal state created by the overvoltage state of the output DC voltage Vout is resolved. On the other hand, if the abnormal state created by the overvoltage state of the output DC voltage Vout is resolved while the switching operation of the switching element 2 is halted, then when the switching operation of the switching element 2 is restarted, the switching operation is continued thereafter. In this way, it is possible to achieve a self-reset type of overvoltage protection in which the operation of the switching power supply apparatus is reset automatically to a normal power supply operation.

Next, a description is given of a self-reset type of overvoltage protection in a switching power supply apparatus which comprises a restart trigger 17c that generates a restart signal when the voltage at the VCC terminal has fallen to the halt voltage VCCOFF a prescribed number of times. This restart trigger 17c comprises a counter circuit which counts up the number of times the voltage at the VCC terminal has fallen to the halt voltage VCCOFF, until the count reaches the prescribed number of times.

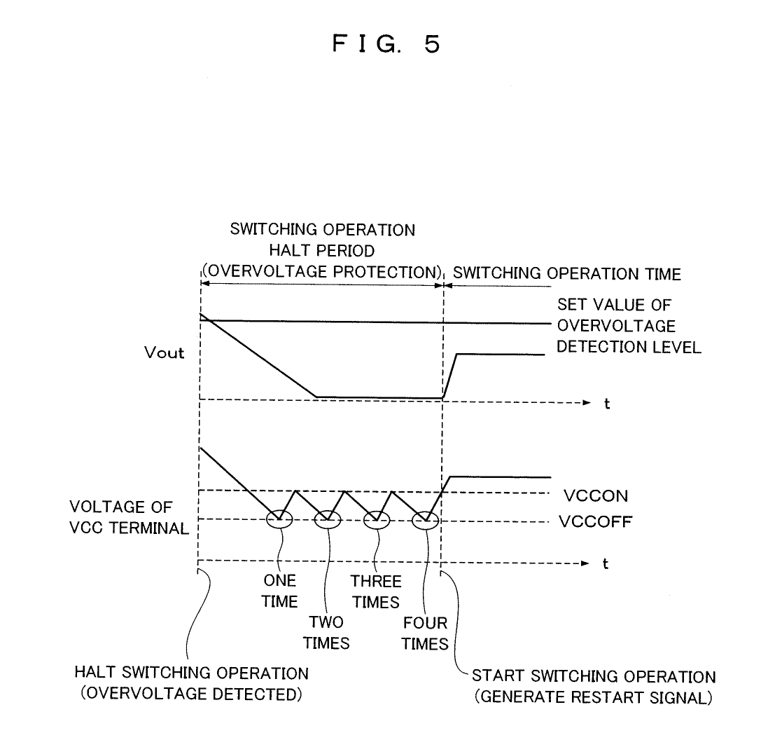

FIG. 5 shows the operating waveforms of the present switching power supply apparatus when the output DC voltage Vout assumes an overvoltage state and the overvoltage protection operates. FIG. 5 shows the output DC voltage Vout and the voltage at the VCC terminal. Furthermore, FIG. 5 shows a case where the restart trigger 17c generates a restart signal, if the voltage at the VCC terminal has fallen to the halt voltage VCCOFF four times.

In this switching power supply apparatus, as shown in FIG. 5, if an overvoltage state is detected and the switching operation of the switching element 2 is halted, then the voltage at the VCC terminal falls and rises repeatedly between the halt voltage VCCOFF and the startup voltage VCCON, and the switching operation of the switching element 2 continues in a halted state until the number of times that the voltage at the VCC terminal has fallen to the halt voltage VCCOFF reaches four. If the count number has reached four, then when the voltage at the VCC terminal subsequently rises to the startup voltage VCCON, the restart trigger 17c generates a restart signal and the switching operation of the switching element 2 is restarted. In this way, it is possible to achieve a self-reset type of overvoltage protection which uses an intermittent timer operating system in which the restart signal is generated only after the voltage at the VCC terminal has repeated a fall and rise cycle four times.

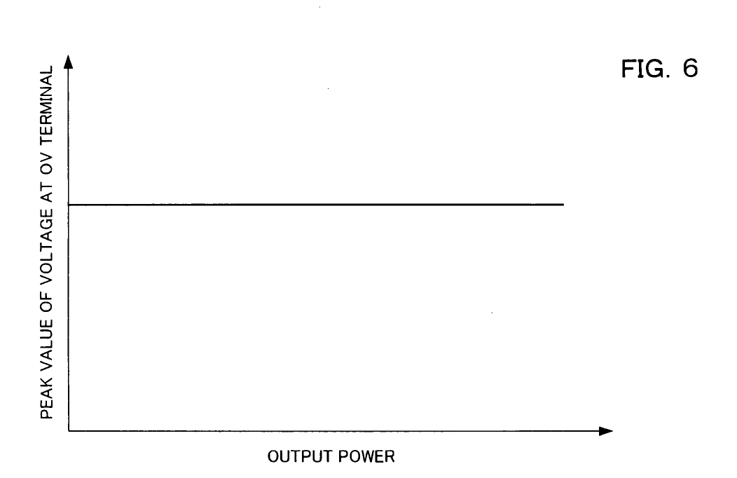

FIG. 6 shows the relationship between the peak value of the voltage at the OV terminal and the output power. As described previously, the voltage at the OV terminal is a voltage achieved by splitting the AC voltage induced in the auxiliary winding 1c by means of the voltage dividing resistors 6a and 6b of the regulating circuit 6. The voltage dividing resistors 6a and 6b which constitute the regulating circuit 6 have the role of removing the ringing component which occurs in the rising part of the voltage in the auxiliary winding 1c, and therefore as shown in FIG. 6, the peak value of the voltage at the OV terminal during normal operation becomes virtually uniform, even if there is a change in the output power. Consequently, the peak value of the voltage at the OV terminal depends only on the change in the output DC voltage Vout and the voltage in the secondary winding 1b.

According to the first embodiment, in comparison with a switching power supply apparatus which detects an overvoltage state by means of a voltage obtained by rectifying and smoothing the voltage of an auxiliary winding which includes in the rising portion thereof a ringing component that changes with variation in the output power, it is possible to carry out accurate overvoltage protection with a high degree of precision, and it is also possible to prevent erroneous operation of overvoltage protection during normal operation.

Moreover, according to the first embodiment, it is possible to adjust the peak value of the voltage at the OV terminal by changing the resistance values (constants) of the voltage dividing resistors 6a and 6b which constitute the regulating circuit 6. For example, if the resistance values of the voltage dividing resistors 6a and 6b are adjusted in such a manner that the peak value of the voltage at the OV terminal during normal operation is set to be lower than the fixed value VOV, the voltage differential between the peak value of the voltage at the OV terminal during normal operation and the fixed value VOV becomes greater, and therefore the voltage level of the output DC voltage Vout at which the overvoltage protection operates (the set value of the overvoltage detection level) is set to be higher. Conversely, if the resistance values of the voltage dividing resistors 6a and 6b are adjusted in such a manner that the peak value of the voltage at the OV terminal during normal operation is set to be higher than the fixed value VOV, then the voltage level of the output DC voltage Vout at which the overvoltage protection operates (the set value of the overvoltage detection level) is set to be lower.

In this way, according to the first embodiment, the voltage level of the output DC voltage Vout at which the overvoltage protection operates (the set value of the overvoltage detection level) can be governed by adjusting the constants of the voltage dividing resistors 6a and 6b which constitute the regulating circuit 6, and therefore the freedom of design of the power supply is increased.

### Second Embodiment

Next, one example of the composition of a switching power supply apparatus relating to a second embodiment of the present invention and a semiconductor device used in this switching power supply apparatus will be described with reference to the drawings. Only those points which differ from the switching power supply apparatus and the semiconductor device relating to the first embodiment described above will be explained.

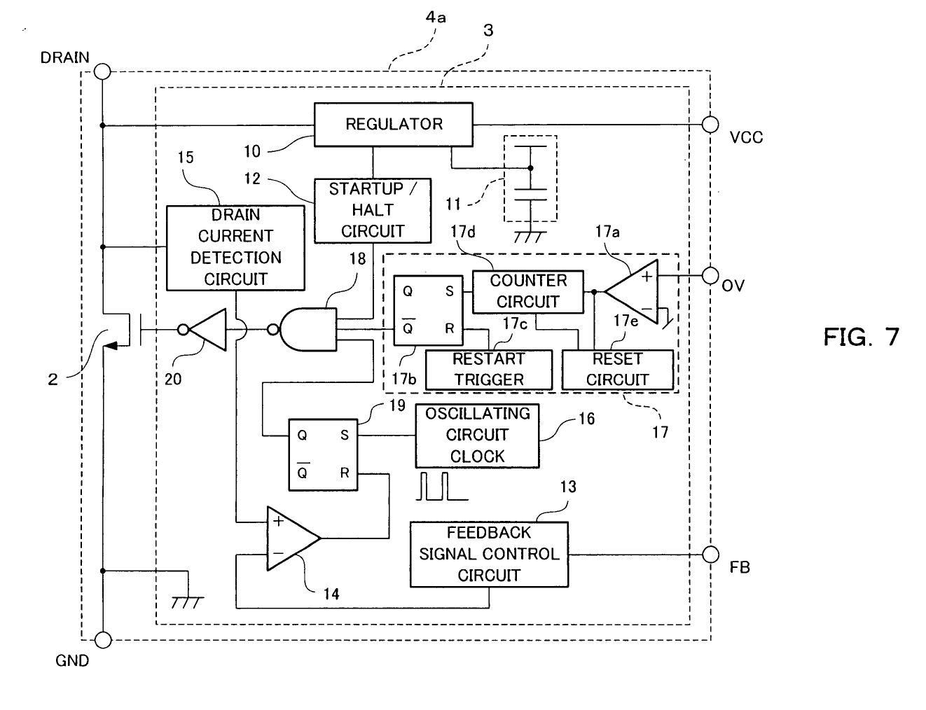

FIG. 7 is a circuit diagram showing one example of the composition of the semiconductor device which is used in the switching power supply apparatus relating to the second embodiment of the present invention. Members which correspond to members that were described in the first embodiment are labeled with the same reference numerals.

This switching power supply apparatus differs from the switching power supply apparatus relating to the first embodiment described above in respect of the composition of a control circuit 3 which is incorporated in a semiconductor device 4a. More specifically, the composition of an overvoltage detection circuit 17 differs from that of the first embodiment which was described above.

As shown in FIG. 7, the overvoltage detection circuit 17 also comprises a counter circuit 17d and a reset circuit 17e. A signal generated by a comparator 17a is supplied to the counter circuit 17d and the reset circuit 17e, a signal generated by the counter circuit 17d is supplied to the S terminal of a flip-flop circuit 17b, and a reset signal generated by the reset circuit 17e is supplied to the counter circuit 17d.

When the peak value of the pulse of the voltage at an OV terminal becomes successively equal to or greater than a fixed value VOV, the counter circuit 17d counts the number of pulses for which the peak value becomes successively equal to or greater than the fixed value VOV. The reset circuit 17e generates a signal which resets the count number of the counter circuit 17d.

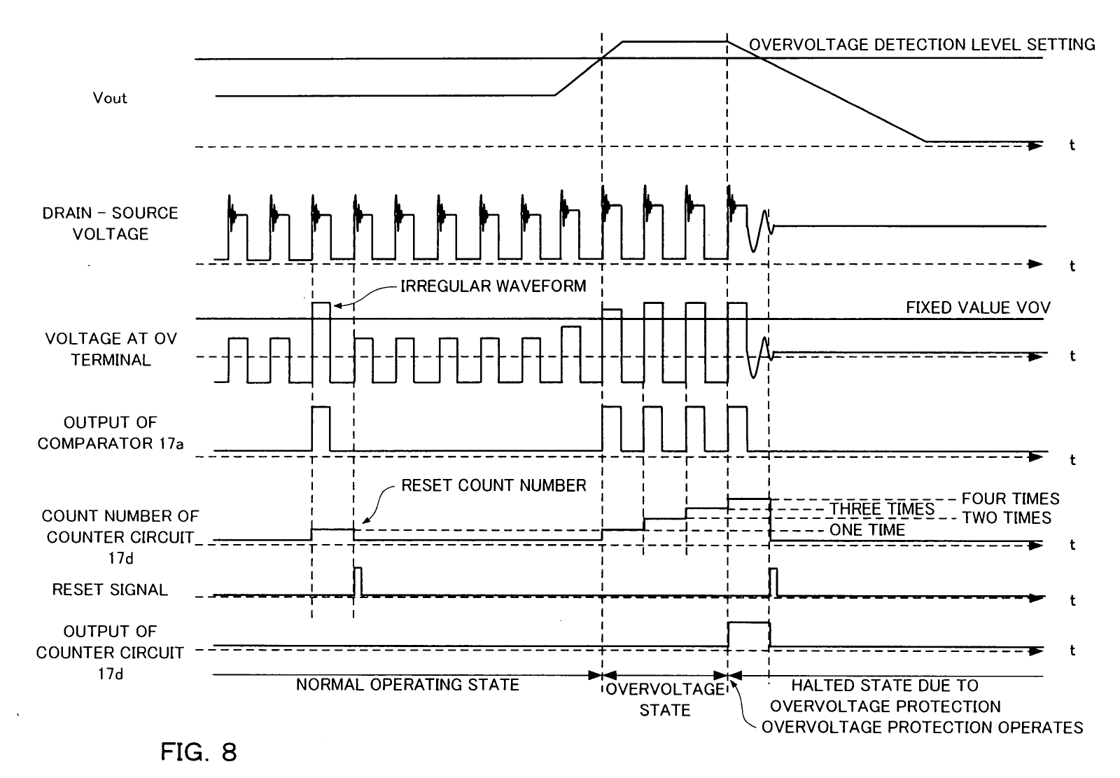

Below, the operation in a case where the semiconductor device 4a shown in FIG. 7 is used instead of the semiconductor device 4 in the switching power supply apparatus shown in FIG. 1 will be described. FIG. 8 shows the operating waveforms of the present switching power supply apparatus when an output DC voltage Vout assumes an overvoltage state and the overvoltage protection operates. FIG. 8 shows the output DC voltage Vout, the drain—source voltage of a switching element 2, an AC voltage occurring in the OV terminal, the output of the comparator 17a, the count number of the counter circuit 17d, the reset signal generated by the reset circuit 17e, and the output of the counter circuit 17d.

As shown in FIG. 8, even if the output DC voltage Vout has assumed an overvoltage state and the voltage at the OV terminal has reached the fixed value VOV, the overvoltage protection does not operate straight away.

If the output DC voltage Vout has assumed an overvoltage state and the peak value of the pulse of the voltage at the OV terminal is successively equal to or greater than the fixed value VOV, then a pulse signal corresponding to the pulse of the voltage at the OV terminal is supplied from the comparator 17a to the counter circuit 17d. The counter circuit 17d counts the number of times that the pulse signal supplied from the comparator 17a has risen. Consequently, the count number increases progressively with each pulse of voltage at the OV terminal. If the count number has reached a specified value, then the level of the signal supplied from the counter circuit 17d to the S terminal of the flip-flop circuit 17b switches from level L to level H, and the level of the signal supplied from the overvoltage detection circuit 17 to the input terminal of a NAND circuit 18 switches from level H to level L. FIG. 8 shows an example in which the level of the signal supplied from the counter circuit 17d switches from level L to level H when the count number has reached four.

If the count number of the counter circuit 17d has reached the predetermined count number, the level of the signal supplied to the input terminal of the NAND circuit 18 from the overvoltage detection circuit 17 is switched from level H to level L, and therefore the overvoltage protection operates and the switching operation of the switching element 2 is halted. In other words, the counter circuit 17d has a role of generating a fixed delay time from the time at which the voltage at the OV terminal reaches the fixed value VOV until the time at which the overvoltage protection operates.

If the level of the signal supplied from the comparator 17a does not switch from level L to level H when the next pulse rises in the voltage at the OV terminal after the level of the signal supplied from the comparator 17a has switched from level H to level L, then the reset circuit 17e generates a reset signal. When the reset signal is supplied to the counter circuit 17d from the reset circuit 17e, the count number which has been counted by the counter circuit 17d is reset.

According to the composition which has been described above, the overvoltage protection only operates in cases where the pulse of the voltage at the OV terminal exceeds the fixed value VOV successively for a fixed period of time until the count number in the counter circuit 17d reaches a prescribed number. Consequently, it is possible to prevent erroneous operation of the overvoltage protection in cases where the output DC voltage Vout is not in an overvoltage state, but where only one pulse of the voltage at the OV terminal exceeds the fixed value VOV, as shown in FIG. 8, for example, or cases where a large peak value which exceeds the fixed value VOV has occurred momentarily in the voltage pulse at the OV terminal.

Consequently, in addition to the beneficial effects relating to the first embodiment described above, it is also possible to prevent erroneous operation of the overvoltage protection which occurs due to the addition of an irregular waveform, such as a surge waveform, to the voltage waveform in the OV terminal, and it is possible to improve the reliability of the switching power supply apparatus yet further.

### Third Embodiment

Next, one example of the composition of a switching power supply apparatus relating to a third embodiment of the present invention and a semiconductor device used in this switching power supply apparatus will be described with reference to the drawings. Only those points which differ from the switching power supply apparatus and the semiconductor device relating to the first and second embodiments described above will be explained.

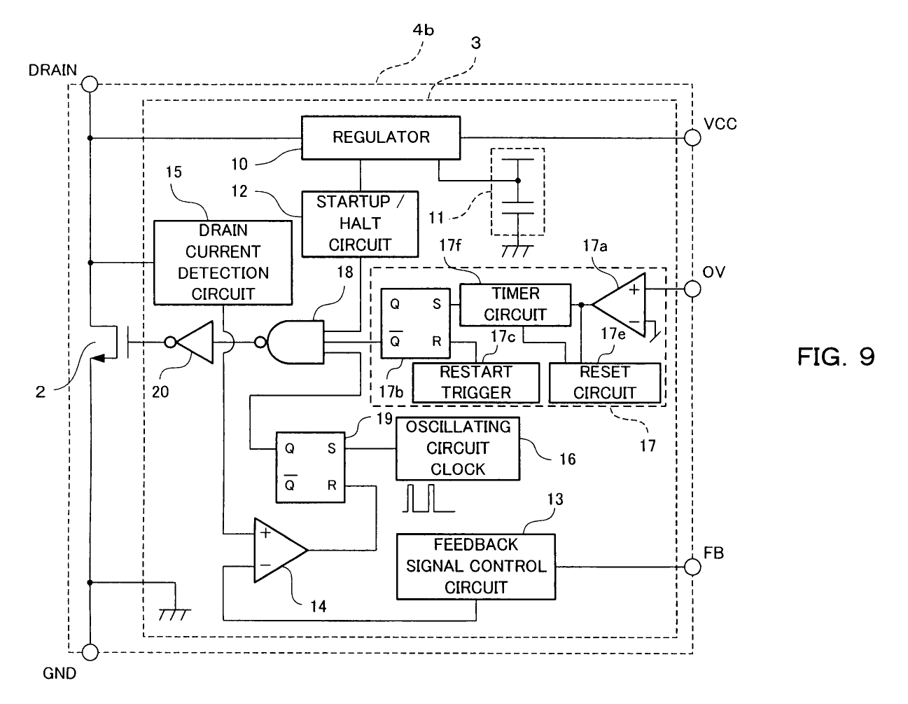

FIG. 9 is a circuit diagram showing one example of the composition of the semiconductor device which is used in the switching power supply apparatus relating to the third embodiment of the present invention. Members which correspond to members that were described in the first and second embodiments are labeled with the same reference numerals.

This switching power supply apparatus differs from the switching power supply apparatus relating to the first and second embodiments described above in respect of the composition of the control circuit 3 which is incorporated in a semiconductor device 4b. More specifically, the composition of the overvoltage detection circuit 17 differs from that of the first and second embodiments which were described above.

As shown in FIG. 9, the overvoltage detection circuit 17 has a composition which includes a timer circuit 17f instead of the counter circuit 17d shown in FIG. 7. In the switching power supply using this semiconductor device 4b, it is possible to obtain similar beneficial effects to the switching power supply apparatus relating to the second embodiment which was described above.

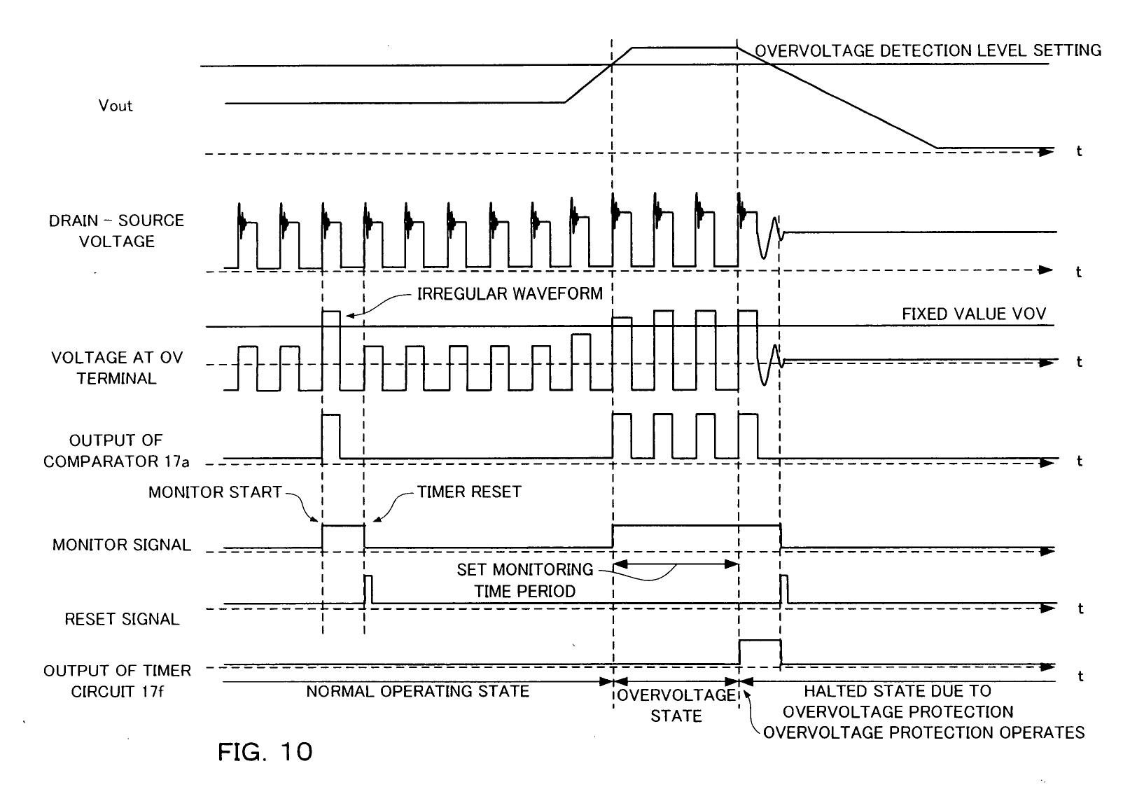

Below, an operation in a case where the semiconductor device 4b shown in FIG. 9 is used instead of the semiconductor device 4 in the switching power supply apparatus shown in FIG. 1 will be described. FIG. 10 shows the operating waveforms of the present switching power supply apparatus when the output DC voltage Vout assumes an overvoltage state and the overvoltage protection operates. FIG. 10 shows the output DC voltage Vout, the drain—source voltage of the switching element 2, the AC voltage occurring at the OV terminal, the output of the comparator 17a, a monitor signal generated inside the timer circuit 17f, the reset signal generated by the reset circuit 17e, and the output of the timer circuit 17f.

As shown in FIG. 10, similarly to the second embodiment, even if the output DC voltage Vout has assumed an overvoltage state and the voltage at the OV terminal has reached the fixed value VOV, the overvoltage protection does not operate straight away.

If the peak value of the pulse of the voltage at the OV terminal has become equal to or greater than the fixed value VOV and the level of the signal supplied from the comparator 17a to the monitor circuit 17f has switched from level L to level H, then the monitor circuit 17f starts to monitor the high peak time period during which the peak value of the pulse of voltage at the OV terminal is successively equal to or greater than the fixed value VOV. More specifically, the monitor circuit 17f generates a monitor signal from the start of the monitoring of the high peak time period until the time that the reset circuit 17e generates a reset signal. If the high peak time period (the time period during which a monitor signal is generated) reaches a predetermined set monitoring time period, then the level of the signal supplied from the timer circuit 17f to the S terminal of the flip-flop circuit 17b switches from level L to level H.

Consequently, if the high peak time period during which the peak value of the pulse of voltage at the OV terminal is successively equal to or greater than the fixed value VOV has reached the predetermined set monitoring time period, then the level of the signal supplied to the input terminal of the NAND circuit 18 from the overvoltage detection circuit 17 switches from level H to level L, and hence the overvoltage protection operates and the switching operation of the switching element 2 is halted. In other words, similarly to the counter circuit 17d which was explained in the second embodiment described above, the timer circuit 17f has a role of generating a uniform delay time from the time at which the voltage at the OV terminal reaches the fixed value VOV until the time at which the overvoltage protection operates.

If the level of the signal supplied from the comparator 17a does not switch from level L to level H when the next pulse rises in the voltage at the OV terminal after the level of the signal supplied from the comparator 17a has switched from level H-to level L, then the reset circuit 17e generates a reset signal. When a reset signal is supplied to the timer circuit 17f from the reset circuit 17e, then the monitoring of the high peak time period by the timer circuit 17f is stopped.

According to the composition described above, similarly to the switching power supply apparatus relating to the second embodiment which was described above, it is possible to prevent erroneous operation of the overvoltage protection and it is possible further to improve the reliability of the switching power supply apparatus.

### Fourth Embodiment

Next, one example of the composition of a switching power supply apparatus relating to a fourth embodiment of the present invention and a semiconductor device used in this switching power supply apparatus will be described with reference to the drawings. Only those points which differ from the switching power supply apparatus and the semiconductor device relating to the first to third embodiments described above will be explained.

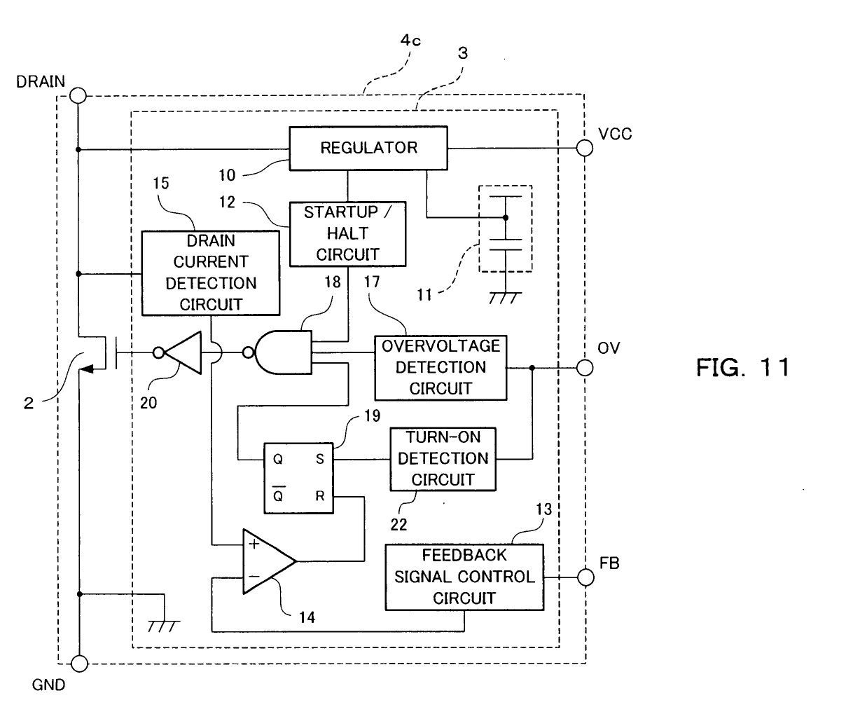

FIG. 11 is a circuit diagram showing one example of the composition of the semiconductor device which is used in the switching power supply apparatus relating to the fourth embodiment of the present invention. Members which correspond to members that were described in the first to third embodiments are labeled with the same reference numerals.

This switching power supply apparatus differs from the switching power supply apparatus relating to the first to third embodiments described above in respect of the composition of the control circuit 3 which is incorporated in a semiconductor device 4c. More specifically, as shown in FIG. 11, the fact that a turn-on detection circuit 21 is provided instead of the oscillating circuit differs from the first to third embodiments which were described above.

The input terminal of the turn-on detection circuit 21 is connected to the OV terminal, and the voltage at the OV terminal (the AC voltage generated by the regulating circuit 6) is supplied to the turn-on detection circuit 21. The output terminal of the turn-on detection circuit 21 is connected to the S terminal of the flip-flop circuit 19. The turn-on detection circuit 21 generates a turn-on detection signal when the voltage at the OV terminal is equal to or lower than a prescribed voltage. The prescribed voltage is set in such a manner that it is possible to detect the ringing voltage which occurs in the auxiliary winding 1c while current is not flowing in the secondary winding 1b of the switching transformer 1. The turn-on detection signal is supplied to the S terminal of the flip-flop circuit 19. Here, the turn-on detection signal is a signal having an H signal level, and the on timing of the switching element 2 is determined by means of this turn-on detection signal. After a turn-on detection signal has been supplied to the S terminal and until the signal supplied to the R terminal has risen, the flip-flop circuit 19 holds the level of the signal supplied to the input terminal of the NAND circuit 18 at level H, and after the signal supplied to the R terminal has risen and until the next turn-on detection signal has been supplied to the S terminal, the flip-flop circuit 19 holds the level of the signal supplied to the input terminal of the NAND circuit 18 at level L.

In this way, the turn-on detection circuit 21 generates a turn-on detection signal which turns on the switching element 2, if it is detected, on the basis of the AC voltage generated by the regulating circuit, that the voltage level of the ringing which occurs in the auxiliary winding 1c while no current is flowing in the secondary winding 1b of the switching transformer 1 has become equal to or lower than a prescribed voltage.

Consequently, in the switching power supply apparatus which uses the semiconductor device 4c shown in FIG. 11, a ringing choke converter (RCC) type of control is carried out in which the switching element 2 is turned on based on the voltage at the OV terminal.

According to the composition described above, in addition to the beneficial effects of the switching power supply apparatus relating to the first to third embodiments described above, it is also possible to obtain the beneficial effects described below. In other words, if the output DC voltage Vout has assumed an overvoltage state and an abnormal state caused by an open connection of the OV terminal has also occurred, then the overvoltage state of the output DC voltage Vout is not detected and the overvoltage protection does not operate. However, simultaneously with this, a voltage signal ceases to be supplied from the OV terminal to the turn-on detection circuit 21, and therefore the switching operation of the switching element 2 is halted. As a result, the transmission of power from the primary winding 1a to the secondary winding 1b of the switching transformer 1 is stopped and the output DC voltage Vout falls. In this way, according to the fourth embodiment, it is possible to obtain a switching power supply apparatus having greater security.

### Fifth Embodiment

Next, one example of the composition of a switching power supply apparatus relating to a fifth embodiment of the present invention and a semiconductor device used in this switching power supply apparatus will be described with reference to the drawings. Only those points which differ from the switching power supply apparatus and the semiconductor device relating to the first to fourth embodiments described above will be explained.

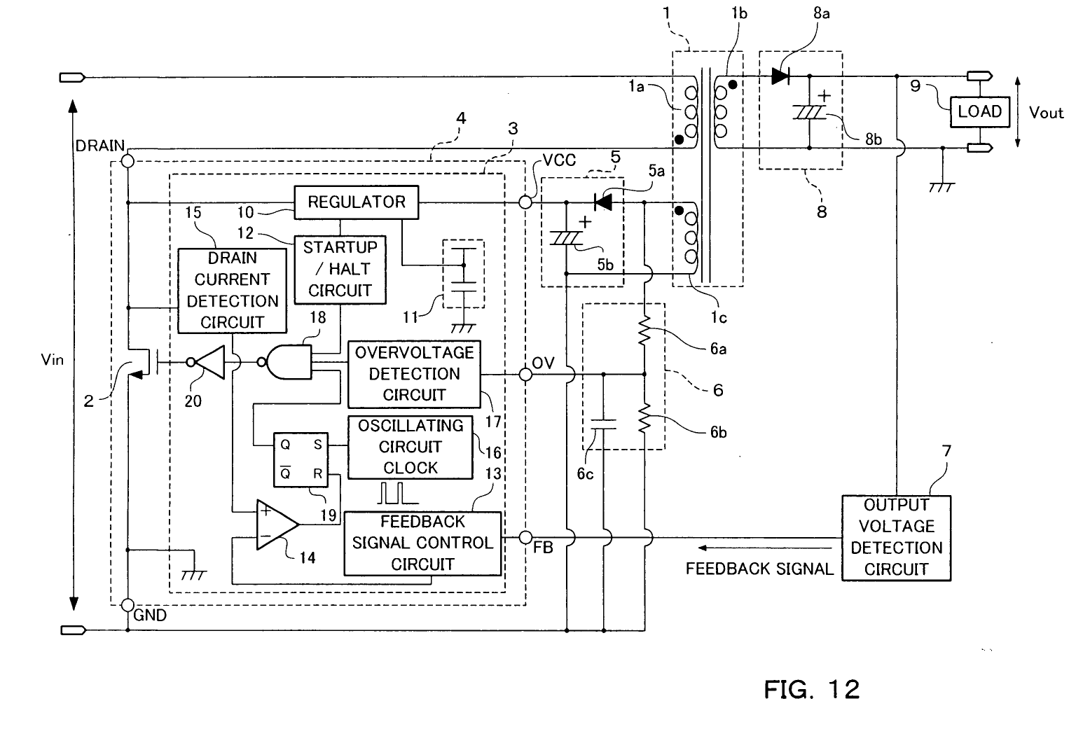

FIG. 12 is a circuit diagram showing one example of the composition of the switching power supply apparatus relating to the fifth embodiment of the present invention. Members which correspond to members that were described in the first to fourth embodiments are labeled with the same reference numerals.

This switching power supply apparatus differs from the switching power supply apparatus relating to the first to fourth embodiments described above in respect of the composition of the regulating circuit 6. More specifically, as shown in FIG. 12, the regulating circuit 6 comprises a capacitor 6c in addition to the voltage dividing resistors 6a and 6b.

According to this composition, the voltage dividing resistors 6a and 6b and the capacitor 6c have the role of a noise filter, and therefore it is possible to achieve highly accurate detection of overvoltage, even in cases where, for example, the voltage of the auxiliary winding 1c includes a high-frequency ringing component.

FIG. 12 shows a composition in which current-mode PWM control is employed as a method for controlling the switching operation of a switching element, but it is of course also possible to employ a ringing choke converter (RCC) method as described above.

In the first to fifth embodiments described above, a method which involves feeding back the feedback signal generated by the output voltage detection circuit 7 to the primary side, was described as the device for stabilizing the output DC voltage Vout to a prescribed voltage, but there are no particular restrictions on the feedback method and it is also possible to adopt a winding feedback system which provides feedback by using the secondary winding and the auxiliary winding of the switching transformer, for example.

Furthermore, the first to fifth embodiments were described above in relation to a case using a semiconductor device in which a switching element and a control circuit for the same are formed on the same semiconductor substrate or a case using a semiconductor device in which a switching element and control circuit are incorporated into the same package, but it is also possible for the switching element and the control circuit to be formed on separate semiconductor substrates.

What is claimed is:

1. A switching power supply apparatus, comprising:
a switching transformer having a primary winding, a secondary winding and an auxiliary winding;
a switching element connected to the primary winding;
an output voltage generating circuit, connected to the secondary winding, for generating an output DC voltage by rectifying and smoothing an AC voltage induced in the secondary winding by a switching operation of the switching element;
a regulating circuit, connected to the auxiliary winding, for generating an AC voltage proportional to a voltage component in which a ringing component of an AC voltage induced in the auxiliary winding by the switching operation of the switching element has been removed; and
a control circuit for controlling the switching operation of the switching element,
wherein the control circuit comprises an overvoltage detection circuit for controlling the switching operation of the switching element so as to reduce the output DC voltage when a peak value of the AC voltage generated by the regulating circuit becomes equal to or greater than a prescribed value.

2. The switching power supply apparatus according to claim 1, wherein the regulating circuit comprises a voltage dividing circuit constituted by a plurality of resistors.

3. The switching power supply apparatus according to claim 1, wherein if the peak value of a pulse of the AC voltage generated by the regulating circuit becomes equal to or greater than a prescribed value, the overvoltage detection circuit counts the number of times that the peak value is successively equal to or greater than the prescribed value, and if the number of times thus counted reaches a predetermined value, the overvoltage detection circuit controls the switching operation of the switching element so as to reduce the output DC voltage.

4. The switching power supply apparatus according to claim 1, wherein if the peak value of a pulse of the AC voltage generated by the regulating circuit becomes equal to or greater than a prescribed value, the overvoltage detection circuit starts monitoring a high peak time period during which the peak value is successively equal to or greater than the prescribed value, and if the high peak time period reaches a predetermined set monitoring time period, the overvoltage detection circuit controls the switching operation of the switching element so as to reduce the output DC voltage.

5. The switching power supply apparatus according to claim 1, wherein the control circuit comprises an oscillating circuit for generating a pulse signal having a fixed period that determines an on timing of the switching element.

6. The switching power supply apparatus according to claim 1, wherein the control circuit comprises a turn-on detection circuit for generating a signal to turn on the switching element when it is detected, on the basis of the AC voltage generated by the regulating circuit, that a voltage level of ringing occurring in the auxiliary winding while current is not flowing in the secondary winding becomes equal to or lower than a prescribed voltage.

7. A semiconductor device used in the switching power supply apparatus according to claim 1, wherein the switching element and the control circuit are formed on a same semiconductor substrate, or are incorporated into a same package.
